(19) United States
(12) Patent Application Publication
(10) Pub. No.: US 2008/0085676 A1
(43) Pub. Date: Apr. 10, 2008

(54) Wireless multi-channel video/audio apparatus

(76) Inventor: Chen-Jen Huang, Kaohsiung Hsien (TW)

Correspondence Address: Hershkovitz & Associates, LLC, 2845 Duke Street, Alexandria, VA, 22314, US

(21) Appl. No.: 11/647,250

(22) Filed: Dec. 29, 2006

(30) Foreign Application Priority Data
Oct. 5, 2006 (TW) 095217816

(51) Int. Cl. H04H 7/00; H04B 1/18

(52) U.S. Cl. 455/3.06; 455/179.1

(57) ABSTRACT

A wireless multi-channel video/audio apparatus has a wireless transmitter to be connected to a video/audio player and multiple sound outputting devices with built-in wireless receivers. The video/audio player outputs an audio signal to the wireless transmitters to be encoded and wirelessly transmitted to the sound outputting devices for generating stereo surround sound effects. Since signal transmission between the player and the sound outputting devices is achieved in a wireless way without using cables, the sound outputting devices can be despised at any positions according to users' requirements.

### BACKGROUND OF THE INVENTION

1. Field of the Invention

The present invention relates to a video/audio apparatus, especially to a video/audio apparatus that wirelessly transmits multi-channel audio signals to respective speakers.

2. Description of the Prior Arts

As the life quality improves, people can obtain many profits from high technology devices. For example, digital technologies have been widely used in multimedia entertainment. The quality of the broadcast sounds of earlier audio devices is poor. However, high-quality hi-fi equipment with stereo multi-channel sound effects nowadays has commonly existed in most families. The stereo sound effect is generated by separating audio signals and then playing the audio signals through different speakers. In 1992, Dolby Laboratories improves its Dolby Surround technology to Dolby Digital, which is a digital stereo sound effect technology. Dolby Digital is a standard containing up to 6 total channels of sound, with 5 channels for normal-range speakers (Right front, Center, Left Front, Right Rear and Left Rear) and one channel for the low-frequency effects (LFE). Multiple speakers are used to generate the stereo effects and should be respectively disposed at particular positions. However, the disposition for these speakers may result in some inconveniences and problems. Since the speakers are connected to the player by the cables, these obvious cables would spoil the original decoration if there is no particular designed layout in the house.

To overcome the shortcomings, the present invention provides a wireless multi-channel video/audio apparatus to mitigate or obviate the aforementioned problems.

### SUMMARY OF THE INVENTION

The main objective of the present invention is to provide a wireless multi-channel apparatus that allows audio signal from a video/audio player to be wirelessly transmitted to multiple sound outputting devices, such as speakers. Therefore, data transmission between the video/audio player and the sound outputting devices do not need to use wires or cables. Further, the sound outputting devices can be disposed at any positions.

To achieve the objective, the apparatus in accordance with the present invention uses a wireless transmitter having an input terminal to connect to a video/audio player to wirelessly transmit an audio signal, and uses multiple sound outputting devices to wirelessly receive the audio signal, decode the audio signal to form a sound signal to be broadcast. Each of the sound outputting device comprises a speaker and a wireless module that receives the audio signal, decodes the audio signal and then transmits the sound signal to the speaker.

Other objectives, advantages and novel features of the invention will become more apparent from the following detailed description when taken in conjunction with the accompanying drawings.

### BRIEF DESCRIPTION OF THE DRAWINGS

FIG. 1 is an operational view of a wireless multi-channel video/audio apparatus in accordance with the present invention;

FIG. 2 is a block diagram of a speaker for the wireless multi-channel video/audio apparatus in accordance with the present invention;

FIG. 3 is a block diagram of a wireless signal receiver for a wireless multi-channel video/audio apparatus in accordance with the present invention;

FIG. 4 is a block diagram of a wireless module in accordance another embodiment of the present invention; and

FIG. 5 is a block diagram of a wireless module in accordance another embodiment of the present invention.

### DETAILED DESCRIPTION OF THE PREFERRED EMBODIMENTS

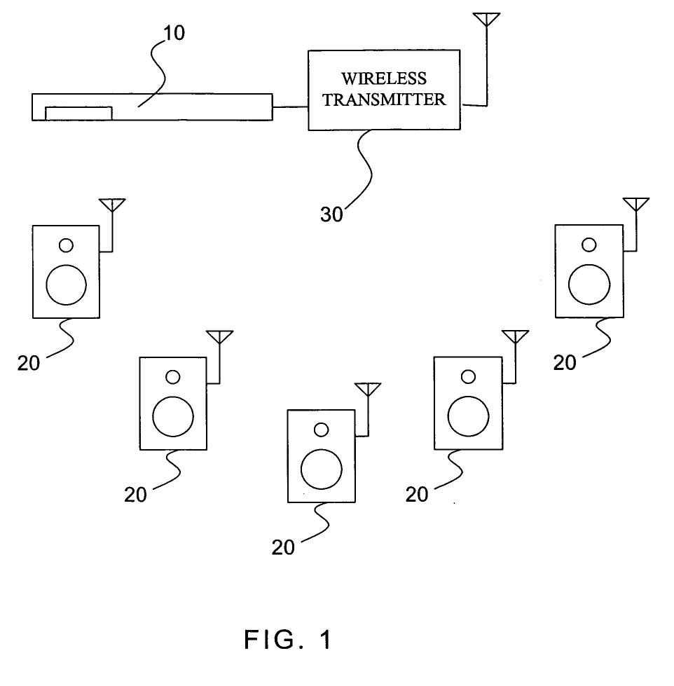

The multi-channel described hereinafter means the commonly used stereo sound effects 5.1 channel configuration or 6.1 channel configuration. With reference to FIG. 1, a video/audio player (10) communicates with multiple sound outputting device (20) in a wireless way. The video/audio player (10) can be a television or a digital multimedia player (DVD, VCD, CD or MP3/MP4). The sound signal of the video/audio player (10) is converted to the multi-channel format and wirelessly transmitted to the sound outputting device (20). Each of the sound outputting device (20) is corresponded to one channel and has abilities of wireless receiving, decoding and amplifying.

The video/audio player (10) uses a wireless transmitter (30) to convert the sound signal to wireless format and then transmit the signal. The wireless transmitter (30) can be an external separate device or built in the video/audio player (10). In this embodiment, the wireless transmitter (30) is a separate device.

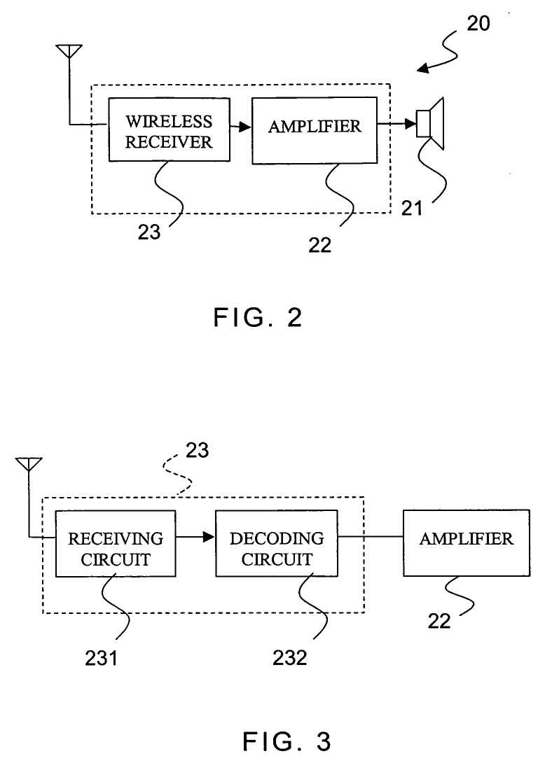

With reference to FIG. 2, each of the sound outputting device (20) comprises a speaker (21) and a wireless module. The wireless module includes a wireless receiver (23) and an amplifier (22). The output terminal of the wireless receiver (23) is connected to the input terminal of the amplifier (22). The output terminal of the amplifier (22) is connected to the speaker (21).

With reference to FIG. 3, the wireless receiver (23) has a receiving circuit (231) and a decoding circuit (232). The input terminal of the receiving circuit (231) is connected to an antenna to receive wireless signal output from the wireless transmitter (30). Upon the reception of the wireless signal, the receiving circuit (231) transmits the signal to the decoding circuit (232). The decoded wireless signal is then output to the amplifier (22) to enhance the signal amplitude. The amplified signal is then output to the sound displaying device (20).

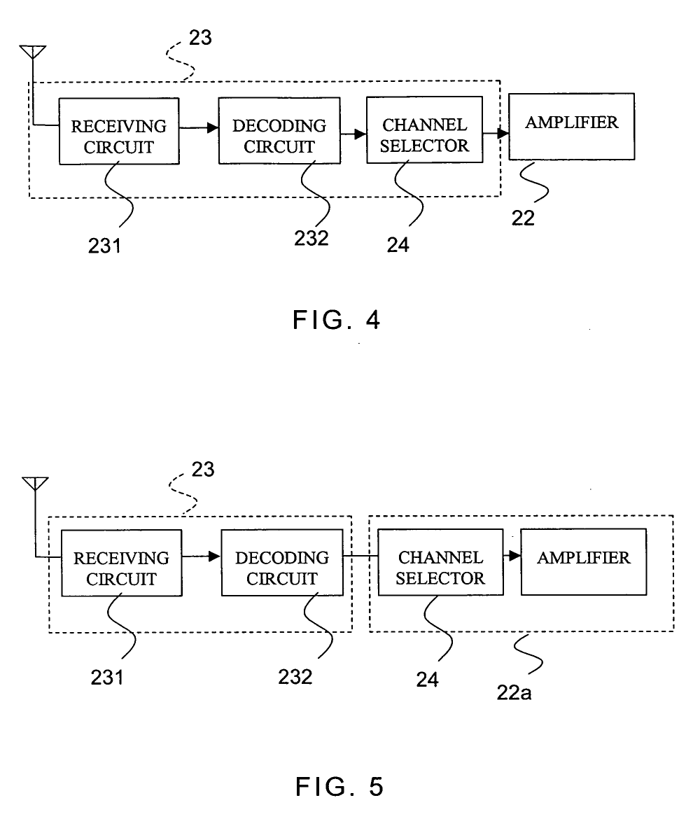

With reference to FIG. 4, the wireless receiver (23) further comprises a channel selector (233). The channel selector (233) can designate a desired channel, i.e. one of the sound outputting devices (20) to play the audio signal.

With reference to FIG. 5, the channel selector (233) can be alternatively incorporated in the amplifier (22a) to designate a desired channel, i.e. one of the sound outputting devices (20) to play the audio signal.

Using the foregoing configuration, the audio signal of the player (10) is transmitted to the sound outputting devices (20) in a wireless way. Since the present invention is used to process the multi-channel audio signals, using the 5.1 channel standard as an example, the outputting devices (20) are corresponded to the right front, center, left front, right rear, left rear and a low-frequency effect channels.

By establishing a wireless transmission between the video/audio player (10) and the sound outputting devices (20), the audio signals of different channels are wirelessly transmitted to the sound outputting device without using any cables. Therefore, the problems or inconveniences resulting from the cables can be avoided.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A wireless multi-channel video/audio apparatus comprising:
a wireless transmitter having an input terminal to connect to a video/audio player to wirelessly transmit an audio signal;
multiple sound outputting devices, each of which wirelessly receives the audio signal from the wireless transmitter, decodes the audio signal to form a sound signal corresponding to one channel to be broadcast and comprises
a speaker; and
a wireless module receiving the audio signal, decoding the audio signal and then transmitting the sound signal to the speaker.

2. The wireless multi-channel video/audio apparatus as claimed in claim 1, the wireless module comprising a wireless receiver and an amplifier,
the wireless receiver having an output terminal connected to the amplifier; and
the amplifier connected to the speaker.

3. The wireless multi-channel video/audio apparatus as claimed in claim 2, the wireless receiver comprising a receiving circuit and a decoding circuit.

4. The wireless multi-channel video/audio apparatus as claimed in claim 1, the wireless transmitter being built in the video/audio player.

5. The wireless multi-channel video/audio apparatus as claimed in claim 1, the wireless transmitter being an external separate device.

6. The wireless multi-channel video/audio apparatus as claimed in claim 1, the video/audio player being a television or a digital multimedia player including DVD, VCD, CD or MP3/MP4 players.

7. The wireless multi-channel video/audio apparatus as claimed in claim 2, the video/audio player being a television or a digital multimedia player including DVD, VCD, CD or MP3/MP4 players.

8. The wireless multi-channel video/audio apparatus as claimed in claim 3, the video/audio player being a television or a digital multimedia player including DVD, VCD, CD or MP3/MP4 players.

9. The wireless multi-channel video/audio apparatus as claimed in claim 4, the video/audio player being a television or a digital multimedia player including DVD, VCD, CD or MP3/MP4 players.

10. The wireless multi-channel video/audio apparatus as claimed in claim 5, the video/audio device being a television or a digital multimedia player including DVD, VCD, CD or MP3/MP4 players.

11. The wireless multi-channel video/audio apparatus as claimed in claim 6, the wireless receiver further comprising a channel selector to choose one of the sound outputting devices for outputting the audio signal.

12. The wireless multi-channel video/audio apparatus as claimed in claim 7, the wireless receiver further comprising a channel selector to choose one of the sound outputting devices for outputting the audio signal.

13. The wireless multi-channel video/audio apparatus as claimed in claim 8, the wireless receiver further comprising a channel selector to choose one of the sound outputting devices for outputting the audio signal.

14. The wireless multi-channel video/audio apparatus as claimed in claim 9, the wireless receiver further comprising a channel selector to choose one of the sound outputting devices for outputting the audio signal.

15. The wireless multi-channel video/audio apparatus as claimed in claim 10, the wireless receiver further comprising a channel selector to choose one of the sound outputting devices for outputting the audio signal.

16. A wireless sound outputting device comprising:
a speaker; and
a wireless module having
a wireless receiver having an output terminal; and
an amplifier connected to the output terminal of the wireless receiver and having an output terminal connected to the speaker.

17. The wireless sound outputting device as claimed in claim 16, the wireless receiver comprising a receiving circuit and a decoding circuit.
